(19) United States
(12) Patent Application Publication
(10) Pub. No.: US 2024/0144016 A1
(43) Pub. Date: May 2, 2024

(54) Artificial Intelligence for Vehicle Performance and Tracking

(71) Applicant: Streetline Technology LLC, San Mateo, CA (US)

(72) Inventors: Taso Zografos, Oakland, CA (US); Dakota Sinclair, Ridgecrest, CA (US); Jia Yi Sinclair, Ridgecrest, CA (US)

(21) Appl. No.: 18/497,771

(22) Filed: Oct. 30, 2023

Related U.S. Application Data
(60) Provisional application No. 63/421,446, filed on Nov. 1, 2022.
(60) Provisional application No. 63/421,440, filed on Nov. 1, 2022.

(51) Int. Cl. G06N 3/084; G07C 5/00; G07C 5/08

(52) U.S. Cl. CPC G06N 3/084; G07C 5/008; G07C 5/0808

(57) ABSTRACT

Provided herein are exemplary systems and methods for using artificial intelligence for vehicle performance and tracking. The system and method are comprised of a plurality of sensory input devices such as ultra-wideband (UWB) positioned throughout the course, the sensors detecting vehicle movement and relaying data regarding vehicle movement to an onboard user device. The onboard user device may push such data to a central processing hub, which may then push such data to a cloud storage network. Additional users may access the data by way of the central processing hub or cloud storage network. Further embodiments may include a vehicular electronic control unit relaying internal vehicle data to the system, and the use of large language models and/or neural networks.

### CROSS-REFERENCE TO RELATED APPLICATIONS

This application claims the priority benefit of U.S. Provisional Patent Application Ser. No. 63/421,446 filed on Nov. 1, 2022 and the priority benefit of U.S. Provisional Patent Application Ser. No. 63/421,440 filed on Nov. 1, 2022 and is related to U.S. Non-Provisional patent application Ser. No. ______ filed on Oct. 30, 2023 the disclosures and appendices of all the above applications are incorporated by reference in their entireties herein.

### FIELD OF THE TECHNOLOGY

Embodiments of the present disclosure relate to the technical field of artificial intelligence and communications networks using sensory input devices, and in particular, but not exclusively, to their use in vehicle performance and tracking.

### SUMMARY OF EXEMPLARY EMBODIMENTS

This summary is provided to introduce a selection of concepts in a simplified form that are further described in the detailed description below.

Vehicle operators need the benefits of communication networks and artificial intelligence for optimal vehicle performance and tracking. The exemplary embodiments herein satisfy that need.

A system and method for tracking the activity of a vehicle within a course are disclosed herein. The system and method are comprised of a plurality of sensory input devices such as ultra-wideband (UWB) positioned throughout the course, the sensors detecting vehicle movement and relaying data regarding vehicle movement to an onboard user device.

The onboard user device may push such data to a central processing hub, which may then push such data to a cloud storage network. Additional users may access the data by way of the central processing hub or cloud storage network. Further embodiments may include a vehicular electronic control unit relaying internal vehicle data to the system.

Further exemplary embodiments include a computer-implemented method of training a neural network for automatically collecting, analyzing, and transmitting data to and from a vehicle, including collecting a first set of data relevant to automatically collecting, analyzing, and transmitting data to and from a vehicle, applying one or more transformations to the collected first set of data to create a first modified set of data, creating a first training set comprising the first collected set of data, the first modified set of data and a first set of non-transformed data, training the neural network in a first stage using the first training set, creating a second training set for a second stage of training comprising the first training set and the first set of non-transformed data that are incorrectly transformed after the first stage of training, and training the neural network in a second stage using the second training set to automatically collect, analyze, and transmit data to and from a vehicle. Additionally, the first collected set of data includes data that originates from a vehicle's engine control unit, including any of the vehicle's engine temperature, engine speed, airflow rate, mass airflow rate, throttle position, spark timing, fuel injection timing, oxygen sensor readings, knock sensor readings, exhaust gas temperature, or exhaust gas oxygen content.

The one or more transformations, according to various exemplary embodiments, may include expanding the first collected set of data by making random changes to the first collected set of data by a random number generator to create the first modified set of data, the first modified set of data being an expanded set of data greater in size than the first collected set of data. The first stage training set may use stochastic learning with backpropagation that uses a gradient of a mathematical loss function to adjust weights of the neural network. The second stage training set may use stochastic learning with backpropagation that uses a gradient of a mathematical loss function to adjust weights of the neural network. The second stage training minimizes false positives by performing an iterative training algorithm, in which the neural network is retrained with an updated training set comprising the false positives produced after the first stage training.

In various exemplary embodiments, the analyzing includes diagnosing a vehicle's condition, tuning a vehicle's performance, improving a vehicle's fuel efficiency, a vehicle's emission control and a vehicle's safety by the neural network.

In other exemplary embodiments, a computer-implemented method of training a neural network for automatically collecting, analyzing, and transmitting data to and from a vehicle includes collecting a first set of data relevant to automatically collecting, analyzing, and transmitting data to and from a vehicle, applying one or more transformations to the collected first set of data to create a first modified set of data, creating a first training set comprising the first collected set of data, the first modified set of data and a first set of non-transformed data, training the neural network in a first stage using the first training set, creating a second training set for a second stage of training comprising the first training set and the first set of non-transformed data that are incorrectly transformed after the first stage of training, and training the neural network in a second stage using the second training set to automatically collect, analyze, and transmit data to and from a vehicle.

Additionally, in some exemplary embodiments, the first collected set of data includes data that originates from a plurality of sensory input devices. A user device may be communicatively coupled to the plurality of sensory input devices and provides data to the plurality of sensory input devices and the first collected set of data. One or more transformations including expanding the first collected set of data by making random changes to the first collected set of data by a random number generator to create the first modified set of data may be performed, with the first modified set of data being an expanded set of data greater in size than the first collected set of data. A first stage training set may use stochastic learning with backpropagation that uses a gradient of a mathematical loss function to adjust weights of the neural network. A second stage training set may use stochastic learning with backpropagation that uses a gradient of a mathematical loss function to adjust weights of the neural network. The second stage training minimizes false positives by performing an iterative training algorithm, in which the neural network is retrained with an updated training set comprising the false positives produced after the first stage training.

In further exemplary embodiments, the analyzing includes determining a geographical vehicle course by the neural network and visualizing it on the user device. The analyzing includes determining a geographical vehicle course by the neural network and visualizing it on the user device, including a vehicle's conformity to staying within the geographical vehicle course.

### BRIEF DESCRIPTION OF THE DRAWINGS

Exemplary embodiments are illustrated by way of example and not limitation in the figures of the accompanying drawings, in which like references indicate similar elements.

FIGS. 1A and 1B comprise a flowchart of an example method of the present disclosure.

FIG. 2 diagrammatically illustrates an example system for executing the method of the present disclosure.

FIG. 3 shows an exemplary large language model.

FIG. 4 shows an exemplary deep neural network.

### DETAILED DESCRIPTION

The systems and methods disclosed herein generally apply to tracking, cars, trucks, race cars, track cars, go-karts, cars used by sporting enthusiasts in predefined or undefined, controlled or uncontrolled environments.

In high-performance racing, there is a need for precise measurements with regard to vehicle speed, handling, and telemetry. High-performance racing may include wheel to wheel racing, time trials, high performance driver education (HPDE), and similar activities.

As drivers navigate a racecourse, they require a significant amount of data regarding their vehicle's speed, handling of turns, location on the course, and proximity to “the line”—an ideal line for the vehicle to follow in order to complete the course in the most time-efficient manner.

Drivers may desire further information pertaining to environmental and internal factors, such as information pertaining to temperature of air at point of intake, throttle usage, center of gravity, momentum and shifts, and brake usage. Such information may be provided by the vehicle's onboard computer or electronic control unit (ECU) or by third party applications that read the ECU through an electronic brakeforce distribution (EBD).

Additionally, drivers may want to share such information with coaches, teammates, competitors, and track organizers, either in real time or after completing a run.

The systems and methods disclosed herein would utilize sensory input devices such as ultra-wideband (UWB) sensors placed throughout a predefined course. According to various embodiments, the systems and methods would further incorporate use of a personal computing device such as a smartphone, tablet, or chip capable of being detected by the sensors, a central processing hub, an EBD reader capable of communicating with the personal computing device and the hub, and/or a cloud network.

An application, or “app”, may be installed on a user's personal computing device. The app may access a local network of sensory input devices and may further be linked to the EBD. Information obtained from the network of sensory input devices and/or the EBD may be used to generate data for the driver.

Using the local network of sensory input devices, the system may triangulate the personal computing device and report the device's location to a central processing hub. The central hub may then compile the collected data.

The network of sensory input devices measure the vehicle's movement along the track and relay the measurements to the central hub.

In some exemplary embodiments, the central hub may generate a visual display of the vehicle's racing line, or pattern of driving, over time.

In further exemplary embodiments, one or more users may use the application to push information to a common data storage pool, such as a cloud network. The network may, in turn, be used to push information to third parties such as audience members or onlookers, coaches, competitors, event hosts, organizers, or teammates.

Such third parties may view data in real time on individual user devices of their own, by way of the application. The information may further be published or retained locally.

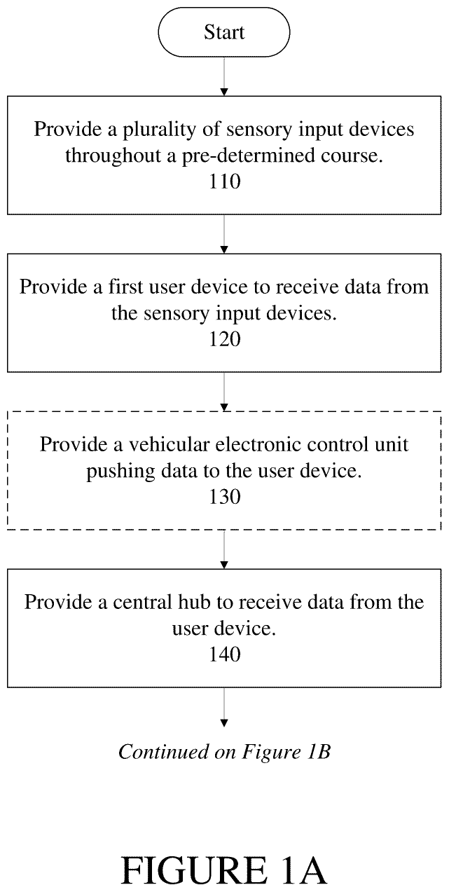

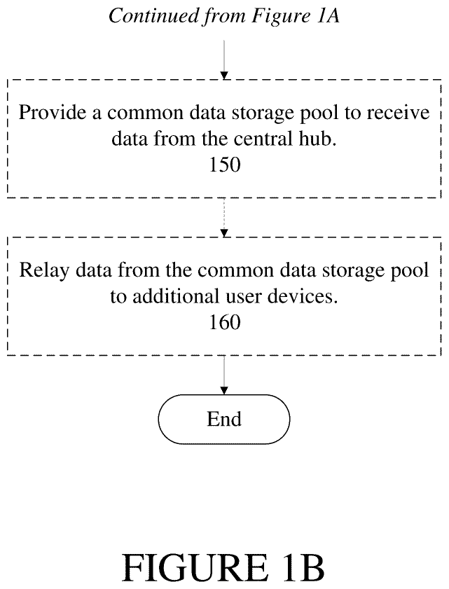

FIG. 1 shows an exemplary method of implementing the system described herein. A plurality of sensory input devices such as UWB sensors are placed throughout a predetermined course 110, such as a racetrack. A user input device, which may include an onboard computer or a personal computer or smartphone, may be programmed using an application to receive data from the sensory input devices 120.

Optionally, the vehicle's electronic control unit may also be configured via the application to push data to the user device 130. Data received from the vehicular electronic control unit may include temperature of air at point of intake, throttle usage, center of gravity, momentum and shifts, and brake usage.

The user device may then push data to a central processing hub 140, which may further push the data to a common data storage pool such as a cloud network 150.

In some preferred embodiments, third parties such as audience members, onlookers, coaches, competitors, event hosts, organizers, and teammates may access such data from the common data storage pool on their own devices 160. Exemplary methods of accessing the data include the use of an application or website.

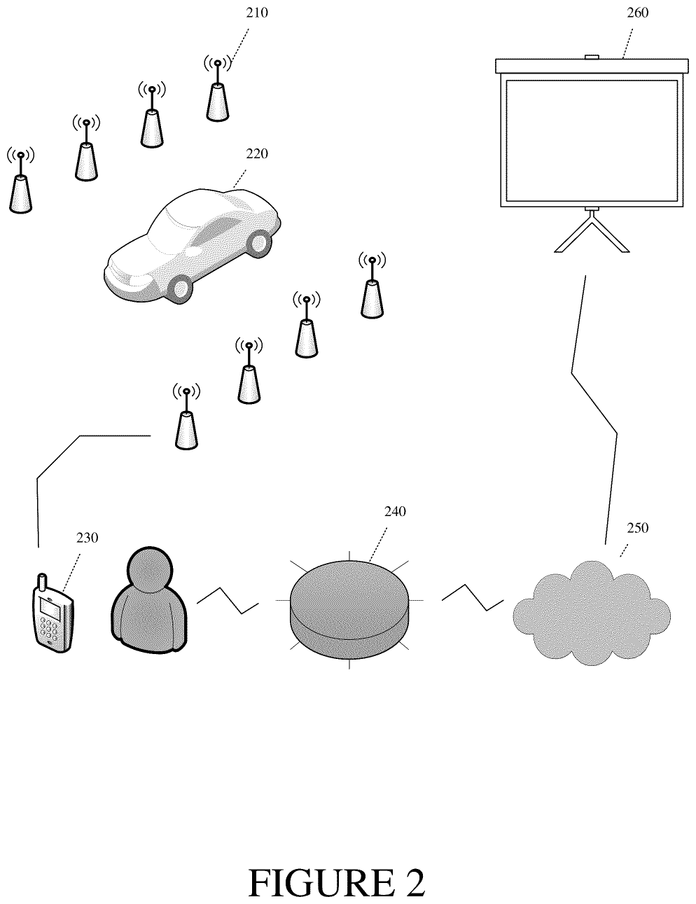

FIG. 2 shows an exemplary embodiment of the system described herein. A plurality of sensors 210 is positioned throughout a course. A first user device 230 is programmed to receive data from the sensory input devices and relay the data to a central hub 240. The first user device may be a driver's personal computing device or smart phone, and in some preferred embodiments would be within the vehicle 220 while tracking is under way.

Data processed by the central hub 240 may be pushed to a common data storage pool such as a cloud network 250, which may then enable access by third parties via additional user devices 260 to the data.

Alternatively, the central hub 250 may push data directly to third parties. Third parties may receive the data by of an application or web interface in some preferred embodiments.

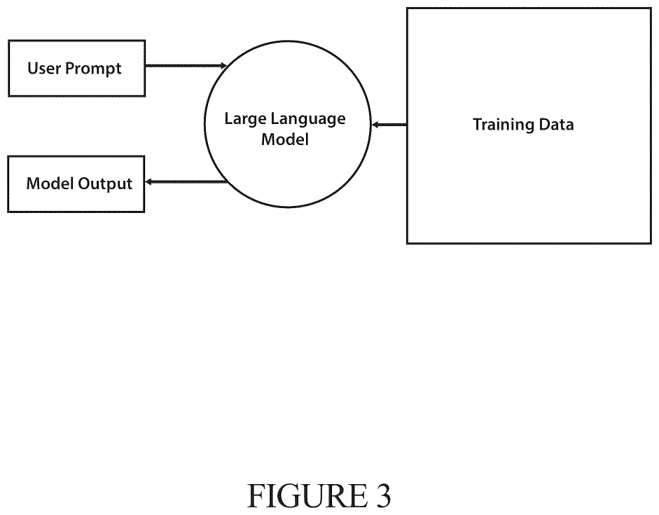

FIG. 3 shows an exemplary large language model.

Vehicle operators need the benefits of communication networks and artificial intelligence for optimal vehicle performance and tracking. The exemplary embodiments herein satisfy that need.

Shown in FIG. 3 is a user prompt, a large language model, training data, and a model output.

A user prompt in a large language model (LLM) is a piece of text that is used to guide the LLM to generate a desired model output. The prompt can be used to specify the type of model output that the LLM should generate, as well as the style and tone of the output.

The quality of the model output generated by an LLM is heavily influenced by the quality of the prompt. A well-crafted prompt will help the LLM to generate output that is more relevant, accurate, and creative.

A large language model (LLM) is a type of artificial intelligence (AI) model that is trained on a massive amount of text data (e.g., training data). This data can be text from books, articles, websites, or any other source of text. The LLM learns the patterns and structure of the text data, and it can then use this knowledge to generate new text, translate languages, write different kinds of creative content, and answer questions in an informative way. An LLM can accomplish tasks in a few seconds that would normally take a human hours or days.

LLMs are advanced artificial intelligence algorithms trained on massive amounts of text data for the purposes of content generation, summarization, translation, classification, sentiment analysis and so much more. Smaller datasets are composed of tens of millions of parameters, while larger sets extend into hundreds of billions of data points. Depending on the purpose of the LLM, the training data will vary. The exemplary artificial intelligence described herein (e.g., LLMs, Neural Networks, Artificial Neural Networks, etc.) are uniquely trained for the special purposes described herein.

Exemplary datasets and their purposes include:

Social media posts: Publicly available social posts can be used to train the model to understand informal language, slang, and online trends, as well as to identify sentiment.

Academic papers: Scholarly articles can be used to understand terminology and technical language, as well as to extract key information.

Web pages: Publicly available web sites can be used to understand writing styles or increase the range of topics a large language model can understand.

Wikipedia: Because of the vast knowledge that Wikipedia houses, this can be used to increase the range of topics a large language model can understand.

Books: Books of various genres can be used to understand different writing styles, storyline development, and narrative structures.

Using the above examples, if a model is trained on social media posts and books, it becomes easier for the model to produce text in a human-like fashion because it has a clear understanding of formal and informal language. So in reality, the answers it produces is highly dependent on the training data used.

Transformer architecture is a neural network architecture that allows for parallel processing and can be used by large language models to process data and generate contextually relevant responses. It consists of a series of layers, with each layer consisting of parallel processing components called attention mechanisms and feedforward networks. The attention mechanisms weigh the importance of each word, using statistical models to learn the relationships between words and their meanings. This allows LLMs to process sequences in parallel and generate contextually relevant responses.

Large language models can process and understand human language at scale. These models use deep learning techniques to analyze vast amounts of text data, making them highly proficient in language processing tasks such as text generation, summarization, translation, and sentiment analysis.

There are also weaknesses with large language models:

Large language models are powerful tools that can provide accurate responses to complex questions. However, despite their impressive capabilities, there is still a risk of inaccurate or false responses, known as “hallucination.”

This phenomenon can have serious implications in critical industries. It is essential to implement safeguards such as human oversight to refine inputs and control outputs to mitigate this risk. Currently, many applications of large language models require human supervision to ensure reliable results but one promising method that aims to fix this is grounding.

Large language models have been trained on a vast amount of text data from the internet. Still, they need enterprise-specific context and domain knowledge to provide specific solutions to industry-specific problems. While they can provide general information and context on various topics, they may not have the depth of understanding and experience required to solve complex, industry-specific challenges.

Additionally, language models may not have access to proprietary information or be aware of the specific regulations and policies that govern a particular industry. As a result, they may only sometimes be able to provide accurate or reliable information in the context of a specific enterprise.

While language models are powerful and accessible to non-experts, they lack controllability. This means their response to a specific input cannot be easily directed or controlled. The layered approach to building LLMs saves time in training complex systems but limits the ability to control the model's responses in a more demanding environment.

To be effective, LLMs must be part of a larger AI architecture that offers control and fine-tuning through additional training, evaluation, and alternative machine learning approaches.

Large language models are trained on vast amounts of text data to understand and respond to natural language in a human-like manner. However, their training data is limited to a specific time period and may not reflect the current state of the world. Updating an LLM's knowledge is complex and requires retraining the model, which is extremely expensive.

Instructing the LLM to override certain parts of its knowledge while retaining others is also challenging. Even then, there is no guarantee that the model will not provide outdated information, even if the search engine it's paired with has up-to-date information. This poses a unique challenge in a business setting where data is often private and constantly changing in real-time.

LLMs are trained on vast amounts of text data, including sensitive personal information, which they may have access to while generating responses. This personal information can be leaked through the model's outputs or training data.

Additionally, the training data used to develop LLMs may not always be properly anonymized or secured, which increases the risk of personal data breaches. The use of LLMs in industries handling sensitive personal information, such as healthcare or finance, requires careful consideration and proper security measures to prevent data leakage.

Artificial neural networks (ANN) first learn from training data and then are later used to make logical inferences from new input data. An input data vector is provided with training data during training sessions and then with new input data when the artificial neural network is used to make inferences. The input data vector is processed with weight data stored in a weighted matrix to create an output data vector.

After processing the input data vector with the weighted matrix, the system creates the output data vector. The output data vector may be combined with an output function to create a final output for the artificial neural network. The output function may be referred to as an activation function. During training sessions, the output data may be compared with a desired target output and the difference between the output data and the desired target output may be used to adjust the weight data within weight matrix to improve the accuracy of the artificial neural network.

Artificial neural networks may comprise many layers of weight matrices such that very complex computational analysis of the input data may be performed. Artificial intelligence relies upon large amounts of very computationally intensive matrix operations to initially learn using training data to adjust the weights in the weight matrices. Later, those adjusted weight matrices are used to perform complex matrix computations with a set of new input data to draw inferences upon the new input data.

LLMs and neural networks can be combined to work together. In some exemplary embodiments, this may be done by using the LLM to generate a set of features that are then fed into the neural network. The neural network can then use these features to make predictions or classifications. For example, in natural language processing, LLMs can be used to generate text features that are then fed into neural networks for tasks such as sentiment analysis, machine translation, and question answering. In computer vision, LLMs can be used to generate image features that are then fed into neural networks for tasks such as object detection, image classification, and scene understanding.

The training of AI includes machine learning (“ML”).

There are three main types of ML: supervised learning, unsupervised learning, and reinforcement learning.

Supervised learning algorithms learn from labeled data, meaning that the input data is paired with the desired output data. For example, a supervised learning algorithm could be used to train an image classification model to identify different types of animals. The training data would consist of images of animals, each labeled with the type of animal in the image.

Unsupervised learning algorithms learn from unlabeled data, meaning that the input data is not paired with any desired output data. For example, an unsupervised learning algorithm could be used to cluster customer data into different groups based on their purchase history.

Reinforcement learning algorithms learn by interacting with their environment. The algorithm receives rewards for taking actions that lead to desired outcomes and penalties for taking actions that lead to undesired outcomes. For example, a reinforcement learning algorithm could be used to train a robot to walk. The robot would receive a reward for taking a step forward and a penalty for falling down.

The specific approach that is used will depend on the specific needs of the application. For example, if the goal is to identify changes as soon as possible, then supervised learning may be a good option. For example, in the case of a moving vehicle, identifying changes as soon as possible warrants the use of supervised learning. However, if the goal is to understand the nuances of an item, then unsupervised learning or reinforcement learning may be a better option.

In addition to the type of learning, the training of AI also depends on the size and quality of the data set. A larger data set will typically lead to better performance, but it may also take longer to train the AI. The quality of the data set is also important, as it should be representative of the types of documents that the AI will be used to analyze.

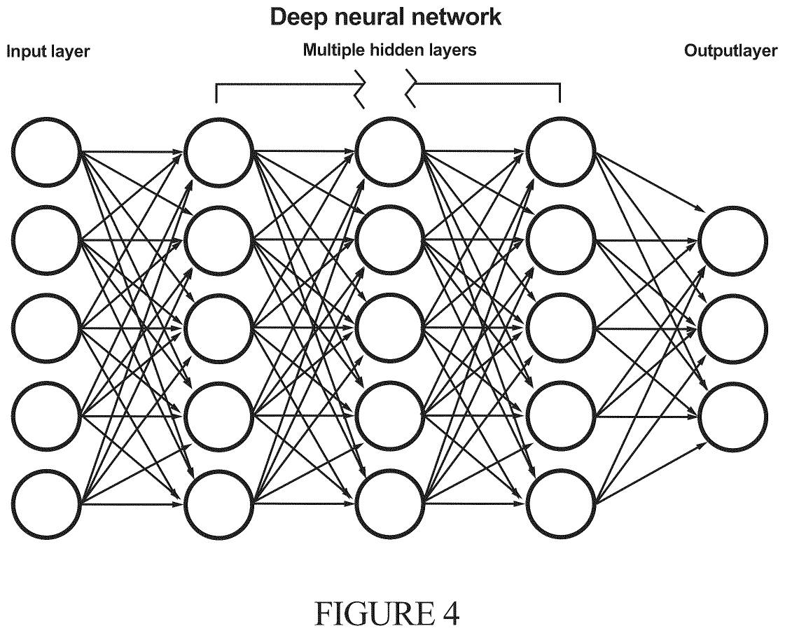

FIG. 4 shows an exemplary deep neural network.

Neural networks, also known as artificial neural networks (ANNs) or simulated neural networks (SNNs), are a subset of machine learning and are at the heart of deep learning algorithms. Their name and structure are inspired by the human brain, mimicking the way that biological neurons signal to one another. Artificial neural networks (ANNs) are comprised of a node layers, containing an input layer, one or more hidden layers, and an output layer. Each node, or artificial neuron, connects to another and has an associated weight and threshold. If the output of any individual node is above the specified threshold value, that node is activated, sending data to the next layer of the network. Otherwise, no data is passed along to the next layer of the network.

Neural networks rely on training data to learn and improve their accuracy over time. However, once these learning algorithms are fine-tuned for accuracy, they are powerful tools in computer science and artificial intelligence, allowing one to classify and cluster data at a high velocity. Tasks in speech recognition or image recognition can take minutes versus hours when compared to the manual identification by human experts.

In some exemplary embodiments, one should view each individual node as its own linear regression model, composed of input data, weights, a bias (or threshold), and an output. Once an input layer is determined, weights are assigned. These weights help determine the importance of any given variable, with larger ones contributing more significantly to the output compared to other inputs. All inputs are then multiplied by their respective weights and then summed. Afterward, the output is passed through an activation function, which determines the output. If that output exceeds a given threshold, it “fires” (or activates) the node, passing data to the next layer in the network. This results in the output of one node becoming in the input of the next node. This process of passing data from one layer to the next layer defines this neural network as a feedforward network. Larger weights signify that particular variables are of greater importance to the decision or outcome.

Most deep neural networks are feedforward, meaning they flow in one direction only, from input to output. However, one can also train a model through backpropagation; that is, move in the opposite direction from output to input. Backpropagation allows one to calculate and attribute the error associated with each neuron, allowing one to adjust and fit the parameters of the model(s) appropriately.

In machine learning, backpropagation is an algorithm for training feedforward neural networks. Generalizations of backpropagation exist for other artificial neural networks (ANNs), and for functions generally. These classes of algorithms are all referred to generically as “backpropagation”. In fitting a neural network, backpropagation computes the gradient of the loss function with respect to the weights of the network for a single input-output example, and does so efficiently, unlike a naive direct computation of the gradient with respect to each weight individually. This efficiency makes it feasible to use gradient methods for training multilayer networks, updating weights to minimize loss; gradient descent, or variants such as stochastic gradient descent, are commonly used. The backpropagation algorithm works by computing the gradient of the loss function with respect to each weight by the chain rule, computing the gradient one layer at a time, iterating backward from the last layer to avoid redundant calculations of intermediate terms in the chain rule; this is an example of dynamic programming. The term backpropagation strictly refers only to the algorithm for computing the gradient, not how the gradient is used; however, the term is often used loosely to refer to the entire learning algorithm, including how the gradient is used, such as by stochastic gradient descent. Backpropagation generalizes the gradient computation in the delta rule, which is the single-layer version of backpropagation, and is in turn generalized by automatic differentiation, where backpropagation is a special case of reverse accumulation (or “reverse mode”).

With respect to FIG. 4, according to exemplary embodiments, the system produces an output, which in turn produces an outcome, which in turn produces an input. In some embodiments, the output may become the input.

### EXAMPLES

### Example One

For example, to train a neural network and a large language model to receive data from a vehicle's engine control unit (ECU), expand the training set, and diagnose an engine's condition, employ these steps:

Collect data from the ECU. For example, over a network, the data should include a variety of engine parameters, such as RPM, throttle position, air intake temperature, and exhaust gas temperature.

Label the data. In order for the neural network and language model to learn to diagnose engine problems, the data needs to be labeled with the corresponding engine condition. For example, review the data and label each data point with the corresponding engine condition, such as “normal,” “misfiring,” or “overheating.”

Split the data into training and test sets. Once the data is labeled, it needs to be split into two sets: a training set and a test set. The training set will be used to train the neural network and language model, while the test set will be used to evaluate the performance of the trained model.

Expand the training set. Since the ECU data may not be representative of all possible engine conditions, expand the training set using techniques such as data augmentation. Data augmentation can be used to generate new data points from the existing data by adding noise, changing the scale or rotation of the data, or combining multiple data points together.

Data augmentation techniques are used to artificially increase the size of a training dataset by creating new data points from existing data. This can be done by making small changes to the data, such as cropping, flipping, rotating, or adding noise. Data augmentation can also be used to create new data points from different perspectives, such as by generating synthetic data. Deep learning models require large amounts of data to train, and data augmentation can help to increase the size of the training dataset without having to collect new data. Data augmentation techniques can be used to improve the performance of machine learning models in a number of ways including reducing overfitting. Overfitting occurs when a machine learning model learns the training data too well and is unable to generalize to new data. Data augmentation can help to reduce overfitting by making the training dataset more diverse. Data augmentation can help to improve the accuracy of machine learning models by providing them with more data to learn from. Data augmentation can also help to improve the robustness of machine learning models by making them less sensitive to noise and variations in the data. In various exemplary embodiments, a variety of data augmentation techniques may be used. This will help to make the training dataset more diverse and reduce overfitting. Augment the training data in a way that is realistic and representative of the data that the model will be exposed to in the real world. Additionally, monitor the performance of the model on both the augmented training data and the original validation data. This will help to ensure that the data augmentation techniques are not harming the performance of the model.

Train the neural network and language model. The neural network and language model can be trained using a variety of machine learning algorithms. The optimal algorithm will depend on the specific data set and the desired accuracy of the model.

A machine learning algorithm is a mathematical procedure or technique that allows computers to learn from data and make predictions or decisions without being explicitly programmed. Machine learning algorithms include:

Linear regression: Linear regression algorithms are used to predict continuous values, such as house prices or sales numbers.

Logistic regression: Logistic regression algorithms are used to predict binary outcomes, such as whether or not a customer will churn or whether or not a patient has a disease.

K-nearest neighbors (KNN): KNN algorithms are used to classify data points by finding the K most similar data points in the training set. Decision trees: Decision tree algorithms are used to classify data points by constructing a tree of decisions.

Support vector machines (SVMs): SVM algorithms are used to classify data points by finding a hyperplane that separates the data into two classes.

Random forests: Random forests are an ensemble learning algorithm that combines the predictions of multiple decision trees to improve accuracy.

Neural networks: Neural networks are a type of machine learning algorithm that is inspired by the structure and function of the human brain. Neural networks can be used for a variety of tasks, including classification, regression, and natural language processing.

Machine learning algorithms are trained on a set of data called the training set. The training set contains examples of the input data and the desired output data. The machine learning algorithm learns from the training set to create a model that can be used to make predictions or decisions on new data. Once a machine learning algorithm is trained, it can be deployed to production. This means that the algorithm can be used to make predictions or decisions on new data without human intervention.

Evaluate the model. Once the neural network and language model are trained, they need to be evaluated on the test set to see how well they perform on unseen data. If the model does not perform well on the test set, it may need to be retrained on a larger training set or using a different algorithm.

Once the neural network and language model are trained and evaluated, they can be deployed on a vehicle to diagnose engine problems. The model can receive data from the ECU in real time and output a diagnosis based on the data.

Additionally, for training a neural network and large language model to diagnose engine condition:

Use a variety of data inputs. In addition to the ECU data, use other data inputs, such as vehicle speed, ambient temperature, and fuel consumption. This will help the model to make more accurate diagnoses.

Use a large training set. The larger the training set, the better the model will be able to learn to diagnose engine problems.

Use a variety of data augmentation techniques. This will help to make the model more robust to unseen data.

Use a cross-validation procedure to evaluate the model. This will help to prevent overfitting and ensure that the model performs well on unseen data.

Deploy the model on a vehicle and monitor its performance. This will help identify any areas where the model can be improved.

Stochastic learning with backpropagation could be used to diagnose engine problems with a neural network being trained to identify patterns in the ECU data that are associated with specific engine fault codes such as patterns in the ECU data that are associated with specific engine components, such as the spark plugs, fuel injectors, or oxygen sensors or trained to identify patterns in the ECU data that are associated with specific engine operating conditions, such as idling, accelerating, or cruising. Once the neural network is trained, it can be deployed on a vehicle to diagnose engine problems in real time. The neural network would receive data from the ECU in real time and output a diagnosis based on the data. The use of stochastic learning with backpropagation to diagnose engine problems has a number of potential benefits, including creating neural networks that are more accurate than traditional diagnostic methods.

### Example Two

The use of ultra-wideband (UWB) sensors laying on the ground tracking a vehicle's position and speed to provide critical data to a large language model (LLM) and neural network (NN) has the potential to improve the accuracy and efficiency of vehicle control. The UWB sensors could be used to provide the LLM and NN with information about the vehicle's surroundings. This information could be used to provide information (e.g., via natural language processing to audio instructions) to the driver to control the vehicle's actuators, such as the throttle and brakes, in order to improve the vehicle's performance and safety. For example, the LLM and NN could use the data from the UWB sensors to predict the vehicle's trajectory and provide information to the driver to adjust the throttle and brakes accordingly to avoid collisions. The UWB sensors could also be used to monitor the condition of the road. This information could be fed into the LLM and NN, which could be trained to identify patterns in the data that are associated with different road conditions, such as potholes, ice, and snow. This could allow the LLM and NN to alert the driver to potential hazards and help them to avoid accidents.

UWB sensors are very accurate, which can lead to more accurate control. UWB sensors can provide real-time data to the LLM and NN, which allows for more timely and effective decisions to be made by the driver.

While exemplary embodiments have been described, it will be understood by those skilled in the art that various changes may be made and equivalents may be substituted for elements thereof without departing from the true spirit of the technology described herein.

What is claimed is:

1. A computer-implemented method of training a neural network for automatically collecting, analyzing, and transmitting data to and from a vehicle, the method comprising:
collecting a first set of data relevant to automatically collecting, analyzing, and transmitting data to and from a vehicle;
applying one or more transformations to the collected first set of data to create a first modified set of data;
creating a first training set comprising the first collected set of data, the first modified set of data and a first set of non-transformed data;
training the neural network in a first stage using the first training set;
creating a second training set for a second stage of training comprising the first training set and the first set of non-transformed data that are incorrectly transformed after the first stage of training; and
training the neural network in a second stage using the second training set to automatically collect, analyze, and transmit data to and from a vehicle.

2. The computer-implemented method of claim 1, further comprising:
the first collected set of data including data that originates from a vehicle's engine control unit.

3. The computer-implemented method of claim 2, further comprising the first collected set of data including any of the vehicle's engine temperature, engine speed, airflow rate, mass airflow rate, throttle position, spark timing, fuel injection timing, oxygen sensor readings, knock sensor readings, exhaust gas temperature, or exhaust gas oxygen content.

4. The computer-implemented method of claim 1, further comprising the one or more transformations including expanding the first collected set of data by making random changes to the first collected set of data by a random number generator to create the first modified set of data, the first modified set of data being an expanded set of data greater in size than the first collected set of data.

5. The computer-implemented method of claim 1, further comprising the first stage training set using stochastic learning with backpropagation that uses a gradient of a mathematical loss function to adjust weights of the neural network.

6. The computer-implemented method of claim 1, the second stage training set using stochastic learning with backpropagation that uses a gradient of a mathematical loss function to adjust weights of the neural network.

7. The computer-implemented method of claim 6, the second stage training minimizing false positives by performing an iterative training algorithm, in which the neural network is retrained with an updated training set comprising the false positives produced after the first stage training.

8. The computer-implemented method of claim 1, further comprising the analyzing including diagnosing a vehicle condition by the neural network.

9. The computer-implemented method of claim 1, further comprising the analyzing including tuning a vehicle's performance by the neural network.

10. The computer-implemented method of claim 1, further comprising the analyzing including improving a vehicle's fuel efficiency by the neural network.

11. The computer-implemented method of claim 1, further comprising the analyzing including improving a vehicle's emission control by the neural network.

12. The computer-implemented method of claim 1, further comprising the analyzing including improving a vehicle's safety by the neural network.

13. A computer-implemented method of training a neural network for automatically collecting, analyzing, and transmitting data to and from a vehicle, the method comprising:
collecting a first set of data relevant to automatically collecting, analyzing, and transmitting data to and from a vehicle;
applying one or more transformations to the collected first set of data to create a first modified set of data;
creating a first training set comprising the first collected set of data, the first modified set of data and a first set of non-transformed data;
training the neural network in a first stage using the first training set;
creating a second training set for a second stage of training comprising the first training set and the first set of non-transformed data that are incorrectly transformed after the first stage of training; and
training the neural network in a second stage using the second training set to automatically collect, analyze, and transmit data to and from a vehicle.

14. The computer-implemented method of claim 13, further comprising:
the first collected set of data including data that originates from a plurality of sensory input devices.

15. The computer-implemented method of claim 14, further comprising a user device communicatively coupled to the plurality of sensory input devices and providing data to the plurality of sensory input devices and the first collected set of data.

16. The computer-implemented method of claim 13, further comprising the one or more transformations including expanding the first collected set of data by making random changes to the first collected set of data by a random number generator to create the first modified set of data, the first modified set of data being an expanded set of data greater in size than the first collected set of data.

17. The computer-implemented method of claim 13, further comprising the first stage training set using stochastic learning with backpropagation that uses a gradient of a mathematical loss function to adjust weights of the neural network.

18. The computer-implemented method of claim 13, the second stage training set using stochastic learning with backpropagation that uses a gradient of a mathematical loss function to adjust weights of the neural network.

19. The computer-implemented method of claim 13, the second stage training minimizing false positives by performing an iterative training algorithm, in which the neural network is retrained with an updated training set comprising the false positives produced after the first stage training.

20. The computer-implemented method of claim 15, further comprising the analyzing including determining a geographical vehicle course by the neural network and visualizing it on the user device.

21. The computer-implemented method of claim 20, further comprising the analyzing including determining a geographical vehicle course by the neural network and visualizing it on the user device including a vehicle's conformity to staying within the geographical vehicle course.
